(19) United States
(12) Patent Application Publication
(10) Pub. No.: US 2025/0089033 A1
(43) Pub. Date: Mar. 13, 2025

(54) USER EQUIPMENT, BASE STATION, AND METHOD FOR TX CHAIN SWITCHING BETWEEN MULTIPLE BANDS

(71) Applicant: SHARP KABUSHIKI KAISHA, Sakai City, Osaka (JP)

(72) Inventors: HAI-HAN WANG, Taipei (TW); CHIA-HUNG WEI, Taipei (TW); CHIE-MING CHOU, Taipei (TW)

(21) Appl. No.: 18/728,808

(22) PCT Filed: Jan. 17, 2023
(86) PCT No.: PCT/CN2023/072670

§ 371 Date: Jul. 12, 2024

Related U.S. Application Data
(60) Provisional application No. 63/304,514, filed on Jan. 28, 2022.

(51) Int. Cl. H04W 72/0453; H04W 72/232; H04W 72/51

(52) U.S. Cl. CPC H04W 72/0453; H04W 72/232; H04W 72/51

(57) ABSTRACT

A method performed by a user equipment (UE) for transmission (Tx) chain switching between multiple bands is provided. The method receives, from a base station (BS), a first radio resource control (RRC) configuration for uplink (UL) Tx chain switching. The method performs a first UL transmission using a first Tx chain on a first band and a second Tx chain on a second band. The method receives downlink control information (DCI) scheduling a second UL transmission on a third band. The method then performs first UL Tx chain switching based on the first RRC configuration and the second UL transmission. The second UL transmission is a 1-port transmission. The first UL Tx chain switching includes switching the first Tx chain to be on the third band and maintaining the second Tx chain on the second band.

### CROSS-REFERENCE TO RELATED APPLICATION(S)

The present disclosure is a National Stage Application of International Patent Application Serial No. PCT/CN2023/072670, filed on Jan. 17, 2023, which claims the benefit of and priority to U.S. Provisional Patent Application Ser. No. 63/304,514, filed on Jan. 28, 2022, the contents of all which are hereby incorporated herein fully by reference into the present disclosure for all purposes.

### FIELD

The present disclosure is related to wireless communication and, more specifically, to a user equipment (UE), a base station (BS), and a method for transmission (Tx) switching between multiple bands.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a user equipment (UE), a base station (BS), and a method for transmission (Tx) switching between multiple bands.

In a first aspect of the present disclosure, a method performed by a UE for Tx chain switching between multiple bands is provided. The method includes receiving, from a base station (BS), a first radio resource control (RRC) configuration for uplink (UL) Tx chain switching; performing a first UL transmission using a first Tx chain on a first band and a second Tx chain on a second band; receiving downlink control information (DCI) scheduling a second UL transmission on a third band; performing first UL Tx chain switching based on the first RRC configuration; and performing the second UL transmission, which is a 1-port transmission. The first UL Tx chain switching includes: switching the first Tx chain to be on the third band, and maintaining the second Tx chain on the second band.

In an implementation of the first aspect, the first UL Tx chain switching further includes switching the first Tx chain to be on the third band and maintained the second Tx chain on the second band in a case that the first RRC configuration indicates that the third band is associated with the second band.

In another implementation of the first aspect, the first RRC configuration indicates a state of Tx chains for the UL Tx chain switching, and the first UL Tx chain switching is performed in a case that the state indicates only one Tx chain to be switched to be on the third band.

In another implementation of the first aspect, the method further includes performing second UL Tx chain switching in a case that the state indicates two Tx chains to be switched to be on the third band, wherein the second UL Tx chain switching includes switching both the first Tx chain and the second Tx chain to be on the third band.

In another implementation of the first aspect, the method further includes reporting, to the BS, a first switching period for UL Tx chain switching between the first band and the third band and a second switching period for UL Tx chain switching between the second band and the third band; and determining not to perform any uplink transmission within a maximum of the first switching period and the second switching period in a case that both the first Tx chain and the second Tx chain are switched to be on the third band.

In another implementation of the first aspect, the method further includes reporting, to the BS, a first switching period for UL Tx chain switching between the first band and the third band and a second switching period for UL Tx chain switching between the second band and the third band; and determining not to perform any uplink transmission within the first switching period in a case that the first Tx chain is switched to be on the third band and the second Tx chain is maintained on the second band.

In another implementation of the first aspect, the method further includes transmitting, to the BS, UE capability information indicating a support of two Tx chains and a support of Tx chain switching between the first band, the second band, and the third band; and receiving, from the BS, a second RRC configuration indicating a band combination including the first band, the second band, and the third band.

In a second aspect of the present disclosure, a UE for Tx chain switching between multiple bands is provided. The UE includes one or more processors and at least one non-transitory computer-readable medium coupled to at least one of the one or more processors, and storing one or more computer-executable instructions that, when executed by the at least one of the one or more processors, cause the UE to receive, from a BS, a first RRC configuration for UL Tx chain switching; perform a first UL transmission using a first Tx chain on a first band and a second Tx chain on a second band; receive DCI scheduling a second UL transmission on a third band; perform first UL Tx chain switching based on the first RRC configuration; and perform the second UL transmission, which is a 1-port transmission. The first UL Tx chain switching includes: switching the first Tx chain to be on the third band, and maintaining the second Tx chain on the second band.

In a third aspect of the present disclosure, a BS for Tx chain switching between multiple bands is provided. The BS includes one or more processors and at least one non-transitory computer-readable medium coupled to at least one of the one or more processors, and storing one or more computer-executable instructions that, when executed by the at least one of the one or more processors, cause the BS to transmit, to a UE, a first RRC configuration for UL Tx chain switching; receive, from the UE, a first UL transmission via a first Tx chain and a second Tx chain of the UE, the first Tx chain being on a first band and the second Tx chain being on a second band; transmit, to the UE, downlink control information (DCI) scheduling a second UL transmission on a third band; and receive, from the UE, the second UL transmission via the first Tx chain and the second Tx chain, the second UL transmission being a 1-port transmission. The second UL transmission is performed in a case that the first Tx chain is switched to be on the third band and the second Tx chain is maintained on the second band, or that both the first Tx chain and the second Tx chain are switched to be on the third band.

In an implementation of the third aspect, the first Tx chain is switched to be on the third band and the second Tx chain is maintained on the second band in a case that the first RRC configuration indicates that the third band is associated with the second band.

In another implementation of the third aspect, the first RRC configuration indicates a state of Tx chains for the UL Tx chain switching.

In another implementation of the third aspect, the first Tx chain is switched to be on the third band and the second Tx chain is maintained on the second band in a case that the state indicates only one Tx chain to be switched to be on the third band; and both the first Tx chain and the second Tx chain are switched to be on the third band in a case that the state indicates two Tx chains to be switched to be on the third band.

In another implementation of the third aspect, the one or more computer-executable instructions, when executed by the at least one of the one or more processors, further cause the BS to receive, from the UE, a first switching period for UL Tx chain switching between the first band and the third band and a second switching period for UL Tx chain switching between the second band and the third band; and determine not to receive any uplink transmission from the UE within a maximum of the first switching period and the second switching period in a case that both the first Tx chain and the second Tx chain are switched to be on the third band.

In another implementation of the third aspect, the one or more computer-executable instructions, when executed by the at least one of the one or more processors, further cause the BS to receive, from the UE, a first switching period for UL Tx chain switching between the first band and the third band and a second switching period for UL Tx chain switching between the second band and the third band; and determine not to receive any uplink transmission from the UE within the first switching period in a case that the first Tx chain is switched to be on the third band and the second Tx chain is maintained on the second band.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a diagram illustrating a UL Tx chain switching, according to an example implementation of the present disclosure.

FIG. 2 is a diagram illustrating a UL Tx chain switching, according to another example implementation of the present disclosure.

FIG. 3 is a diagram illustrating a UL Tx chain switching, according to another example implementation of the present disclosure.

FIG. 4 is a diagram illustrating a UL Tx chain switching, according to another example implementation of the present disclosure.

FIG. 5 is a diagram illustrating a scheduling timeline for simultaneous UL transmissions, according to an example implementation of the present disclosure.

FIG. 6 is a flowchart illustrating a method/process performed by a UE for Tx chain switching between multiple bands, according to an example implementation of the present disclosure.

FIG. 7 is a flowchart illustrating a method/process performed by a BS for Tx chain switching between multiple bands, according to an example implementation of the present disclosure.

FIG. 8 is a block diagram illustrating a node for wireless communication in accordance with various aspects of the present disclosure.

### DETAILED DESCRIPTION

Some abbreviations used in this disclosure may include the following:

| Abbreviation | Full name |
|---|---|
| 3GPP | 3^{rd} Generation Partnership Project |
| 5G | 5^{th} Generation |
| BS | Base Station |
| BWP | Bandwidth Part |
| CA | Carrier Aggregation |
| CCE | Control Channel Element |
| CG | Configured Grant |
| CN | Core Network |
| CORESET | Control Resource Set |
| DC | Dual Connectivity |
| DCI | Downlink Control Information |
| DG | Dynamic Grant |
| DL | Downlink |
| DMRS | Demodulation Reference Signal |
| DRX | Discontinuous Reception |
| EN-DC | E-UTRA NR Dual Connectivity |
| E-UTRA | Evolved Universal Terrestrial Radio Access |
| E-UTRAN | Evolved Universal Terrestrial Radio Access Network |
| EPC | Evolved Packet System |
| HARQ | Hybrid Automatic Repeat Request |
| IE | Information Element |
| LBT | Listen Before Talk |
| LTE | Long-Term Evolution |
| MAC | Medium Access Control |
| MAC CE | MAC Control Element |
| MCG | Master Cell Group |
| MCS | Modulation Coding Scheme |
| MN | Master Node |
| NR | New Radio |
| NW | Network |
| OFDM | Orthogonal Frequency Division Multiplexing |
| PCell | Primary Cell |
| PRB | Physical Resource Block |
| PUCCH | Physical Uplink Control Channel |
| PUSCH | Physical Uplink Shared Channel |
| RAT | Radio Access Technology |
| RAN | Radio Access Network |
| Rel | Release |
| RF | Radio Frequency |
| RRC | Radio Resource Control |
| SCS | Sub-Carrier Spacing |
| SL | Sidelink |
| SCell | Secondary Cell |
| SCG | Secondary Cell Group |
| SN | Secondary Node |
| SpCell | Special Cell |
| SRS | Sounding Reference Signal |
| SUL | Supplementary Uplink |
| TDD | Time Division Duplex |
| TDM | Time-Division Multiplexing |
| TS | Technical Specification |
| TTI | Transmission Time Interval |
| UE | User Equipment |
| UL | Uplink |
| URLLC | Ultra-Reliable and Low-Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present disclosure,” etc., may indicate that the implementation(s) of the present disclosure so described may include a particular feature, structure, or characteristic, but not every possible implementation of the present disclosure necessarily includes the particular feature, structure, or characteristic. Further, repeated use of the phrase “in one implementation,” “in an example implementation,” or “an implementation,” do not necessarily refer to the same implementation, although they may. Moreover, any use of phrases like “implementations” in connection with “the present disclosure” are never meant to characterize that all implementations of the present disclosure must include the particular feature, structure, or characteristic, and should instead be understood to mean “at least some implementations of the present disclosure” include the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer-executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or using one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT), such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next-generation Node B (gNB) in the 5G-RAN, or any other apparatus capable of controlling radio communication and managing radio resources within a cell. The BS may serve one or more UEs via a radio interface.

The BS may be operable to provide radio coverage to a specific geographical area using multiple cells forming the RAN. The BS may support the operations of the cells. Each cell may be operable to provide services to at least one UE within its radio coverage.

Each cell (often referred to as a serving cell) may provide services to serve one or more UEs within its radio coverage such that each cell schedules the DL and optionally UL resources to at least one UE within its radio coverage for DL and optionally UL packet transmissions. The BS may communicate with one or more UEs in the radio communication system via the multiple cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may be referred to as the SpCell of an MCG. A Primary SCG Cell (PSCell) may be referred to as the SpCell of an SCG. The MCG may be referred to as a group of serving cells associated with the Master Node (MN), including the SpCell and optionally one or more Secondary Cells (SCells). An SCG may be referred to as a group of serving cells associated with the Secondary Node (SN), including the SpCell and optionally one or more SCells.

As previously disclosed, the frame structure for NR may support flexible configurations for accommodating various next-generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes may be considered for NR, specifically Low-Density Parity-Check (LDPC) code and Polar Code. The coding scheme adaption may be configured based on channel conditions and/or service applications.

At least DL transmission data, a guard period, and UL transmission data may be included in a transmission time interval (TTI) of a single NR frame. The respective portions of the DL transmission data, the guard period, and the UL transmission data may also be configurable based on, for example, the network dynamics of NR. The SL resources may also be provided in an NR frame to support ProSe services or V2X services.

A subset of the total cell bandwidth of a cell may be referred to as a bandwidth part (BWP) and beamwidth part adaptation may be achieved by configuring the UE with BWP(s) and telling the UE which of the configured BWPs is currently the active one. To enable bandwidth adaptation (BA) on the PCell, the gNB may configure the UE with UL and DL BWP(s). To enable BA on SCells in case of CA, the gNB may configure the UE with DL BWP(s) at least (e.g., there may not be any BWP in the UL). For the PCell, the initial BWP may be the BWP used for initial access. For the SCell(s), the initial BWP may be the BWP configured for the UE to first operate at SCell activation. The UE may be configured with a first active UL BWP by a particular IE, such as a firstActiveUpiinkBWP IE. If the first active UL BWP is configured for an SpCell, the firstActiveUplinkBWP IE field may include the ID of the UL BWP to be activated upon performing the RRC (re-)configuration. If this field is absent, the RRC (re-)configuration may not impose a BWP switch. If the first active UL BWP is configured for an SCell, the firstActiveUplinkBWP IE field may include the ID of the UL BWP to be used upon MAC-activation of the SCell.

In the current NR specifications, a UE with 2 Tx chains (or called a 2Tx UE) may be configured with at most 2 UL bands, which may be changed only by the RRC reconfiguration, and the UL Tx chain switching may only be performed between 2 UL bands for a 2Tx UE. Dynamically selecting carriers with UL Tx chain switching, e.g., based on the data traffic, the TDD DL/UL configuration, or the bandwidth and channel condition of each band, instead of RRC-based cell(s) reconfiguration, may potentially lead to higher UL data rate, spectrum utilization, and UL capacity.

In Rel-15 of the NR specifications, the RF requirements for inter-band UL CA, SA SUL, and inter-band EN-DC may be specified assuming 0 microsecond (s) switching period between 2 UL carriers when TDM is operated, causing the UE not being able to support 2Tx transmission when the UE needs to switch carrier but no switching period is reserved for the UE. In Rel-16 of the NR specifications, the switching period between case 1 and case 2 (e.g., as shown below in Table 1) may be introduced to achieve enhancement on the UL performance with 2Tx transmission on one UL carrier for inter-band UL CA, SA SUL, and inter-band EN-DC. For such enhancement, time mask including the switching period and the transient period between 2 carriers may be specified in the 3GPP TS 38.101-1. For inter-band UL CA and SA SUL, the switching periods may be used in either NR carrier as indicated in RRC signaling (which means transmission in the NR carrier indicated by the RRC signaling may be interrupted by the switching periods), while for inter-band EN-DC, the switching periods may be only used in NR carrier (which means transmission in the NR carrier may be interrupted by the switching periods). The UE capability of Tx chain switching period may be reported via a particular IE, such as the uplinkTxSwithingPeriod IE, which may indicate 35 s, 140 s, or 210 s (210 s is only for inter-band UL CA and SA SUL). Meanwhile, the UE DL interruption may be allowed when the UE is configured with difficult band combinations. As shown in Table 1, carrier 1 may only support at most 1 Tx in case 1 and case 2, and Tx chain switching between case 1 and case 2 may be referred to as 1Tx-2Tx chain switching.

TABLE 1
Tx chain switching scenario 1 (Rel-16)

| | Number of Tx chains (carrier 1 + carrier 2) |
|---|---|
| Case 1 | 1T + 1T |
| Case 2 | 0T + 2T |

In Rel-17 of the NR specifications, more scenarios may be supported for Tx chain switching between two carriers. As shown in Table 2, both carrier 1 and carrier 2 support at most 2 Tx in case 2 and case 3, and Tx chain switching between case 2 and case 3 may be referred to as 2Tx-2Tx chain switching. As shown in Table 3, Tx chain switching between case 1, case 2, and case 3 may be referred to as 2Tx-2Tx chain switching.

TABLE 2
Tx chain switching scenario 2 (Rel-17)

| | Number of Tx chains (carrier 1 + carrier 2) |
|---|---|
| Case 2 | 0T + 2T |
| Case 3 | 2T + 0T |

TABLE 3
Tx chain switching scenario 3 (Rel-17)

| | Number of Tx chains (carrier 1 + carrier 2) |
|---|---|
| Case 1 | 1T + 1T |
| Case 2 | 0T + 2T |
| Case 3 | 2T + 0T |

In Rel-17 of the NR specifications, more scenarios for Tx chain switching between two bands (e.g., band A and band B) may be supported. In the scenarios shown in Table 4, Table 5, and Table 6, there may be 1 carrier on band A and 2 contiguous aggregated carriers on band B, and band A may be for SUL or non-SUL and band B may be a non-SUL band.

TABLE 4
Tx chain switching scenario 4 (Rel-17)

| | Number of Tx chains (band A + band B) |
|---|---|
| Case 1 | 1T + 1T |
| Case 2 | 0T + 2T |

TABLE 5
Tx chain switching scenario 5 (Rel-17)

| | Number of Tx chains (band A + band B) |
|---|---|
| Case 2 | 0T + 2T |
| Case 3 | 2T + 0T |

TABLE 6
Tx chain switching scenario 6 (Rel-17)

| | Number of Tx chains (band A + band B) |
|---|---|
| Case 1 | 1T + 1T |
| Case 2 | 0T + 2T |
| Case 3 | 2T + 0T |

Two options may be supported for Tx chain switching for UL CA. In option 1, a UE may not transmit simultaneously on two UL bands. On the other hand, in option 2, a UE may transmit simultaneously on two UL bands. Whether either option 1 or option 2, or both option 1 and option 2 is/are supported may be reported via UE capability signaling to the gNB, and which option is used may be explicitly configured, e.g., via dedicated RRC signaling, to the UE. For Tx chain switching for SUL, similar to option 1 for UL CA, a UE may not transmit simultaneously on two UL carriers of a serving cell. The mapping of Tx chains to antenna ports for option 1 (and SUL) and option 2 in the above scenarios are shown below in Table 7 to Table 14. For example, Table 7 shows the mapping of Tx chains to antenna ports for option 1 (or SUL) Tx chain switching in scenario 1. Since, in option 1 (or SUL), a UE only performs one UL transmission on one UL band at a time, even though 2 Tx chains are on two bands, respectively, (e.g., 1Tx on carrier 1 and 1 Tx on carrier 2) in case 1, the UE may only perform a 1-port transmission on carrier 1. On the other hand, in case 2, 2 Tx chains may be both on carrier 2. In case 2, the UE may perform 1-port or 2-port transmission on carrier 2. It should be noted that 1 Tx may be available for 2 contiguous carriers on band B. That is, if the state of Tx chains is 1Tx on band A and 1Tx on band B, 1Tx may be available simultaneously on both UL carriers on band B for the UE. If the state of Tx chains is 0Tx on band A and 2Tx on band B, 2Tx may be available simultaneously on both UL carriers on band B for the UE.

TABLE 7
Option 1/SUL Tx chain switching for scenario 1 (Rel-16)

| | | Number of antenna ports |
|---|---|---|
| | Number of Tx chains | for UL transmission |
| | (carrier 1 + carrier 2) | (carrier 1 + carrier 2) |
| Case 1 | 1T + 1T | 1P + 0P |
| Case 2 | 0T + 2T | 0P + 2P, 0P + 1P |

TABLE 8
Option 2 Tx chain switching for scenario 1 (Rel-16)

| | | Number of antenna ports |
|---|---|---|
| | Number of Tx chains | for UL transmission |
| | (carrier 1 + carrier 2) | (carrier 1 + carrier 2) |
| Case 1 | 1T + 1T | 1P + 0P, 1P + 1P, 0P + 1P |
| Case 2 | 0T + 2T | 0P + 2P, 0P + 1P |

TABLE 9
Option 1/SUL Tx chain switching for scenario 2 (Rel-17)

| | | Number of antenna ports |
|---|---|---|
| | Number of Tx chains | for UL transmission |
| | (carrier 1 + carrier 2) | (carrier 1 + carrier 2) |
| Case 2 | 0T + 2T | 0P + 2P, 0P + 1P |
| Case 3 | 2T + 0T | 2P + 0P, 1P + 0P |

TABLE 10
Option 2 Tx chain switching for scenario 3 (Rel-17)

| | | Number of antenna ports |
|---|---|---|
| | Number of Tx chains | for UL transmission |
| | (carrier 1 + carrier 2) | (carrier 1 + carrier 2) |
| Case 1 | 1T + 1T | 1P + 0P, 1P + 1P, 0P + 1P |
| Case 2 | 0T + 2T | 0P + 2P, 0P + 1P |
| Case 3 | 2T + 0T | 2P + 0P, 1P + 0P |

TABLE 11
Option 1/SUL Tx chain switching for scenario 4 (Rel-17)

| | | Number of antenna ports |
|---|---|---|
| | | for UL transmission |
| | Number of Tx chains | (band A (carrier 1) + band B |
| | (band A + band B) | (carrier 2 + carrier 3)) |
| Case 1 | 1T + 1T | 1P + (0P + 0P) |
| Case 2 | 0T + 2T | 0P + (2P + 0P), 0P + (0P + 2P), 0P + |
| | | (2P + 2P), 0P + (1P + 0P), 0P + (0P + |
| | | 1P), 0P + (1P + 1P), 0P + (1P + 2P), |
| | | 0P + (2P + 1P) |

TABLE 12
Option 2 Tx chain switching for scenario 4 (Rel-17)

| | | Number of antenna ports |
|---|---|---|
| | | for UL transmission |
| | Number of Tx chains | (band A (carrier 1) + band B |
| | (band A + band B) | (carrier 2 + carrier 3)) |
| Case 1 | 1T + 1T | 1P + (0P + 0P), 1P + (1P + 0P), 1P + |
| | | (0P + 1P), 1P + (1P + 1P), 0P + (1P + |
| | | 0P), (0P + 0P + 1P), 0P + (1P + 1P) |
| Case 2 | 0T + 2T | 0P + (2P + 0P), 0P + (0P + 2P), 0P + |
| | | (2P + 2P), 0P + (1P + 0P), 0P + (0P + |
| | | 1P), 0P + (1P + 1P), 0P + (1P + 2P), |
| | | 0P + (2P + 1P) |

TABLE 13
Option 1/SUL Tx chain switching for scenario 5 (Rel-17)

| | | Number of antenna ports |
|---|---|---|
| | | for UL transmission |
| | Number of Tx chains | (band A (carrier 1) + band B |
| | (band A + band B) | (carrier 2 + carrier 3)) |
| Case 2 | 0T + 2T | 0P + (2P + 0P), 0P + (0P + 2P), 0P + |
| | | (2P + 2P), 0P + (1P + 0P), 0P + (0P + |
| | | 1P), 0P + (1P + 1P), 0P + (1P + 2P), |
| | | 0P + (2P + 1P) |
| Case 3 | 2T + 0T | 2P + (0P + 0P), 1P + (0P + 0P) |

TABLE 14
Option 2 Tx chain switching for scenario 6 (Rel-17)

| | | Number of antenna ports |
|---|---|---|
| | | for UL transmission |
| | Number of Tx chains | (band A (carrier 1) + band B |
| | (band A + band B) | (carrier 2 + carrier 3)) |
| Case 1 | 1T + 1T | 1P + (0P + 0P), 1P + (1P + 0P), 1P + |
| | | (0P + 1P), 1P + (1P + 1P), 0P + (1P + |
| | | 0P), 0P + (0P + 1P), 0P + (1P + 1P) |
| Case 2 | 0T + 2T | 0P + (2P + 0P), 0P + (0P + 2P), 0P + |
| | | (2P + 2P), 0P + (1P + 0P), 0P + (0P + |
| | | 1P), 0P + (1P + 1P), 0P + (1P + 2P), |
| | | 0P + (2P + 1P) |
| Case 3 | 2T + 0T | 2P + (0P + 0P), 1P + (0P + 0P) |

Tx chain switching between case 1, case 2, and case 3 may be triggered by any type of UL transmission (e.g., Dynamic Grant (DG) PUSCH, Configured Grant (CG) PUSCH, PUCCH, SRS, and/or PRACH). When Tx chain switching is triggered, a switching period may be needed for the UE to switch one or two Tx chains (e.g., to be on other bands). During the switching period, the UE may not perform UL transmission on either of the two bands. If Tx chain switching is triggered for a UL transmission starting at T₀, the UE may not be expected to perform any UL transmission during T₀-T_{switch} to T₀, where T_{switch} may be the length of the switching period. T_{switch} may be different for 1 Tx-2Tx chain switching and 2Tx-2Tx chain switching. The gNB may avoid scheduling or configuring any UL transmission during T₀-T_{switch} to T₀. If the gNB does not avoid scheduling or configuring any UL transmission during T₀-T_{switch} to T₀, UL transmission on one of the two bands may be interrupted by Tx chain switching. The gNB may configure the switching location to be one of the two bands. The UL transmission on the band configured with the switching location may be interrupted if the time gap between the end of a UL transmission before the Tx chain switching and T₀ is less than T_{switch}. For example, if 2 Tx chains are on band A before the Tx chain switching and 2 Tx chains are on band B after the Tx chain switching, the UL transmission in band B after the Tx chain switching may start at T₀, the end of a UL transmission in band A before the Tx chain switching may be at T₁, which is greater than T₀-T_{switch}, and the switching location may be configured to be band B. The UE may then finish the UL transmission in band A first, and perform Tx chain switching after the UL transmission in band A is finished. As a result, since the UL transmission in band B may only be started after the Tx chain switching is performed, the UE may start the UL transmission in band B after T₀.

### Configured Grant

In Rel-15 of the NR specifications, a UE in an RRC_CONNECTED state may be provided with a CG. The CG may include a Type-1 CG or a Type-2 CG. For a Type-1 CG, the UE may directly use the CG for UL transmission after receiving the CG configuration. For a Type-2 CG, the UE may not directly use the CG for UL transmission after receiving the CG configuration, and may need to receive an activation DCI activating the CG, so that the UE may use the CG for UL transmission. A CG configuration may include a time domain symbol allocation, frequency resource allocation, DMRS configuration, modulation and coding scheme (MCS), periodicity, number of repetitions, and number of HARQ processes, etc. The PUSCH occasions configured by the CG configuration may occur periodically in the time domain with the configured periodicity. Within each period, the PUSCH occasions may be in consecutive slots when the number of repetitions is greater than 1, and the number of consecutive slots may be the same as the number of repetitions. That is, one slot may include one PUSCH occasion, which may be used for one repetition, and each PUSCH occasion may be associated with the same symbol allocation. The HARQ process ID for a PUSCH occasion may be determined based on the system frame number (SFN) and the slot number corresponding to the slot in which the PUSCH occasion is located. Specifically, the HARQ process ID associated with the first symbol of a UL transmission may be determined based on the formula, as specified, for example, in the 3GPP TS 38.321.

### DCI Transmission

In Rel-15 of the NR specifications, the DCI may be transmitted using one or more control channel elements (CCEs) included in a CORESET. The configurations of a CORESET may include the PRBs consisting of the frequency domain resource of the CORESET, and the number of OFDM symbols consisting of the time domain resource of the CORESET. One or more search spaces may be associated with a CORESET. A search space may define the frequency of occurrence of the associated CORESET, and one occurrence of the CORESET may be referred to as a monitoring occasion. The configuration of a search space may include the periodicity and the time offset of the search space, and the duration of the search space (e.g., the consecutive number of slots in which one or more monitoring occasions exists). If the duration is 1, only one or more monitoring occasion within one slot may exist in each period.

To achieve higher UL data rates, spectrum utilization, and UL capacity, a UE may be configured via dedicated RRC signaling with more than two UL carriers on more than two bands. The UE may perform UL transmissions simultaneously on at most two of the more than two bands that are configured. In some implementations, the UE may need to perform Tx chain switching before a UL transmission can be performed. For example, when the UE is scheduled or configured to transmit a new UL transmission on a band, and a previous UL transmission was performed on two bands different than the band, the UE may need to perform the Tx chain switching before the new UL transmission.

The possible scenarios of Tx chain states for at least three carriers on three bands are shown below in Table 15.

TABLE 15
Tx chains states for three bands

| | Number of Tx chains (band A + band B + band C) |
|---|---|
| Case 1 | 1T + 1T + 0T |
| Case 2 | 0T + 1T + 1T |
| Case 3 | 1T + 0T + 1T |
| Case 4 | 0T + 2T + 0T |
| Case 5 | 0T + 0T + 2T |
| Case 6 | 2T + 0T + 0T |

The possible scenarios of Tx chain states for at least four carriers on four bands are shown below in Table 16.

TABLE 16
Tx chains states for four bands

| | Number of Tx chains (band A + band B + band C + band D) |
|---|---|
| Case 1 | 1T + 1T + 0T + 0T |
| Case 2 | 0T + 1T + 1T + 0T |
| Case 3 | 1T + 0T + 1T + 0T |
| Case 4 | 0T + 2T + 0T + 0T |
| Case 5 | 0T + 0T + 2T + 0T |
| Case 6 | 2T + 0T + 0T + 0T |
| Case 7 | 1T + 0T + 0T + 1T |
| Case 8 | 0T + 1T + 0T + 1T |
| Case 9 | 0T + 0T + 1T + 1T |
| Case 10 | 0T + 0T + 0T + 2T |

### Ambiguity of the Tx Chain State

scenario a: current Tx chain state may be 2 Tx chains on one band and there may be a 1-port transmission scheduled or configured on another band. For example, when current Tx chain state is case 4 (as shown in Table 15 and Table 16 above) and there is a 1-port transmission scheduled on band A, it may be unclear whether the Tx chain state is case 1, case 3, or case 6, after the Tx chain switching is performed.
scenario b: current Tx chain state may be 2 Tx chains on 2 bands, respectively, and there may be a 1-port transmission scheduled or configured on a band other than the 2 bands. For example, when current Tx chain state is case 1 (as shown in Table 15 and Table 16 above) and there is a 1-port transmission scheduled on band C, it may be unclear whether the Tx chain state is case 2, case 3, or case 5, after the Tx chain switching is performed.

For at least the above-identified scenario a and scenario b, a method/mechanism may be needed to determine the Tx chain state after the Tx chain switching is performed.

### Problems in Determining 1Tx-2Tx or 2Tx-2Tx Mode/Switching Period

In Rel-17 of the NR specifications, when the 1Tx-2Tx mode is used, a 1Tx-2Tx chain switching period may be used. When the 2Tx-2Tx mode is used, a 2Tx-2Tx chain switching period may be used. Depending on the UE capability, the 1Tx-2Tx chain switching period may be shorter than the 2Tx-2Tx chain switching period. An RRC parameter may be introduced in Rel-17 to explicitly indicate whether the 1Tx-2Tx mode or the 2Tx-2Tx mode is used.

When more than two bands are configured, it may be possible that some bands may be scheduled or configured with at most 1-port transmission, while some bands may be scheduled or configured with at most 2-port transmission. If a Tx chain switching is triggered, 2 Tx chains may be within a band pair before and after the Tx chain switching (e.g., Tx chain switching from case 1 to case 3 in Table 15) and the band pair may include a first band (e.g., band A) that may be scheduled or configured with at most 1-port transmission and a second band (e.g., band B) that may be scheduled or configured with at most 2-port transmission, then the Tx chain switching within the band pair may be performed using the 1Tx-2Tx chain switching period. In this case, if a band (e.g., band C) other than the bands included in the band pair may be scheduled or configured with at most 2-port transmission, then the Tx chain switching that involves switching one or two Tx chains between band B and band C may be performed using the 2Tx-2Tx chain switching period. That is, whether the 1Tx-2Tx mode or the 2Tx-2Tx mode is used, and whether the 1Tx-2Tx chain switching period or the 2Tx-2Tx chain switching period is used, may not be clearly determined by the RRC parameter introduced in Rel-17 when more than two bands are configured.

### Problems in Determining the Length and Location of Switching Period

In Rel-16 and Rel-17 of the NR specifications, the length of switching period may be reported per band pair and per band combination. For example, for a band combination of band 1, band 3, and band 41, as specified in the 3GPP TS 38.101-1, the UE may report one or more band pairs within the band combination for which the UE supports the Tx chain switching, and the length of switching period may be reported for each reported band pair, which may be the same or different. For example, the UE may report 35 s for band pair {Band 1, Band 3} and report 140 s for band pair {Band 3, Band 41}. When more than two bands are configured, Tx chain switching may involve more than two bands. For example, when switching from case 1 to case 6 in Table 15, three bands may be involved before and after the Tx chain switching. A method/mechanism may be needed to determine the length of switching period.

In Rel-16 and Rel-17 of the NR specifications, the location of switching period may be configured on one of the configured two bands via dedicated RRC signaling. When more than two bands are configured, it may be not clear whether the switching location can be configured on more than one band. If the switching location can be configured on more than one band, it may be unclear how to determine the location of the switching period for the case where Tx chain switching involves two bands that are both configured with the switching location. If the switching location cannot be configured on more than one band, it may be unclear how to determine the location of the switching period for the case where Tx chain switching involves two bands that are not both configured with the switching location. A method/mechanism may be needed to determine the location of switching period.

### Problems in Triggering Condition for a Tx Chain Switching

To determine whether a Tx chain switching is needed for a UL transmission, the UE may need to be aware of the Tx chain state. Before the scheduled or configured UL transmission is performed, the UE may need to determine all UL transmissions that will be performed simultaneously including the scheduled or configured UL transmission. If the UE is able to perform all the UL transmissions simultaneously based the current Tx chain state, the UE may not perform the Tx chain switching. Otherwise, if the UE is unable to perform all the UL transmissions simultaneously based on the current Tx chain state, the UE may perform the Tx chain switching. However, it may be needed to define how the UE determines all the UL transmissions that will be performed simultaneously. For example, the definition of simultaneous UL transmissions may have to be made clear.

### Solutions to Ambiguity of Tx Chain State

To deal with the issues regarding ambiguity of the Tx chain states, the following preferred embodiments are proposed. In the following, a per-band configuration may be configured in the UL configuration (e.g., via the upinkConfig IE) of one or more carriers on a band. When more than one carrier is configured on the band, the configuration may be the same for the more than one carrier on the band. For an RRC parameter that is configured per band or per band pair, a list of the RRC parameters may be included in a particular IE, such as the CellGroupConfig IE, and to which band or band pair an RRC parameter in the list is applied may be explicitly indicated in the RRC parameter or may be implicitly determined by the order of the RRC parameters in the list.

Method 1-1: For scenario a, an RRC parameter may be configured per band or per band pair. The RRC parameter may indicate one of the following two alternatives. The first alternative may be that 2 Tx chains are switched to be on the band on which the UL transmission is configured or scheduled. The second alternative may be that 1 Tx chain is switched to be on the band on which the UL transmission is configured or scheduled, and 1Tx is maintained on the band on which the latest UL transmission was performed before the Tx chain switching.

For per-band configuration, if both Tx chains are on a first band, a 1-port transmission on a second band may be scheduled or configured, and the second band may be configured with the RRC parameter that indicates the first alternative, then both Tx chains may be switched to be on the second band. Otherwise, if the second alternative is indicated by the RRC parameter, 1 Tx chain may be switched to be on the second band and 1Tx chain may be maintained on the first band.

For per-band-pair configuration, if both Tx chains are on a first band, a 1-port transmission on a second band may be scheduled or configured, and the band pair {the first band, the second band} may be configured with the RRC parameter that indicates the first alternative, then both Tx chains may be switched to be on the second band. Otherwise, if the second alternative is indicated by the RRC parameter, 1 Tx chain may be switched to be on the second band and 1Tx chain may be maintained on the first band.

In some implementations, the RRC parameter may be configured per UE. That is, the same alternative may apply to all bands.

In some implementations, a third alternative may be indicated by the RRC parameter which is configured per band or per carrier. In the third alternative, a specific case may be configured for the second band. For example, case 2 in Table 15 may be configured for band B. Then, if the second band is band B, 1Tx chain may be on band B and 1 Tx chain may be on band C after Tx chain switching.

Method 1-2: For scenario b, the following alternatives may be used.

Alt. 1-1: Configure a list of bands per band. When the band is scheduled or configured with a UL transmission that triggers a Tx chain switching, the UE may switch a Tx chain to be on a band based on the list of bands. For example, the UE may determine to switch the Tx chain to be on a band that is included in the list. When more than one Tx chain is on the bands that are included in the list, the UE may determine to switch a Tx chain based on the order of the bands in the list. For example, if one Tx chain of the UE is on band A, another Tx chain of the UE is on band B, band C is scheduled or configured with a UL transmission that triggers a Tx chain switching, and the list of bands configured for band C is (band A, band B), the UE may switch the Tx chain on band A to be on band C. In some implementations, the list may be configured per UE, and the UE may determine which Tx chain to switch based on the above described method by excluding from the list the band that is scheduled or configured with the UL transmission that triggers the Tx chain switching. In some implementations, the list may be provided via system information.

Alt. 1-2: Configure an anchor band per band pair. For example, if the current band pair is {band A, band B}, band A may be the anchor band for the current band pair, and a 1-port transmission may be scheduled on band C, then the Tx chain on band B may be switched to be on band C. The anchor band may be determined based on the band index. In some implementations, the band with the smallest, or largest, index may be determined as the anchor band. The anchor band may be a band configured to serve the primary serving cell. The anchor band of a band pair may be determined implicitly, as the band that includes the carrier with the smallest serving cell index of the carriers on the bands of the band pair.

Alt. 1-3: Configure a priority per band. The UE may determine to switch the Tx chain on a band with a lower priority to be on the band scheduled or configured with a UL transmission that triggers the Tx chain switching.

Alt. 2-1: The target case (e.g., one of cases 1 to 6 in Table 15), may be explicitly indicated by a field in the DCI that schedules the UL transmission that triggers a Tx chain switching.

Alt. 2-2: The Tx chain that needs to be switched to be on the target band may be explicitly indicated by a field in the DCI that schedules the UL transmission that triggers a Tx chain switching.

Alt. 3: Use a band-pair-based operation. Switching between band pairs may be triggered explicitly by DCI or a MAC CE. For example, if the current band pair is {band A, band B}, a 1-port transmission on band C may be scheduled after the band pair is switched to be on {band A, band C} or {band B, band C} by DCI or a MAC CE. As another example, the DCI scheduling the UL transmission on band C may indicate to the UE to switch the band pair to be on {band A, band C} or {band B, band C}.

Alt. 4: Switch a Tx chain that requires a smaller/shorter Tx chain switching period (compared to switching the other Tx chain). For example, if the current Tx chain state is 1 Tx chain on band A and 1 Tx chain on band B, the Tx chain switching period corresponding to the Tx chain state that 1 Tx chain is on band B and 1 Tx chain is on band C may be shorter than the Tx chain switching period corresponding to the Tx chain state that 1 Tx chain is on band A and 1 Tx chain is on band C, and a 1-port transmission may be scheduled or configured on band C, then the current Tx chain state may be switched to the Tx chain state with the smaller/shorter Tx chain switching period.

Alt. 5: The RRC parameter in Method 1-1 may be used. It should be noted that scenario b may be resolved by indicating the first alternative or the third alternative in Method 1-1. That is, a specific case may be configured per band or per carrier, and the RRC configuration may indicate that 2 Tx chains may be switched to be on the target band or indicate the specific case where 1 Tx chain is on the target band and 1 Tx chain is on another band. For example, if the current Tx chain state is case 1, as shown in Table 15 (1 Tx chain on band A and 1 Tx chain on band B), and a UL transmission is scheduled on band C, the UE may determine on which bands the Tx chains are to be after the Tx chain switching based on the RRC configuration for band C. For example, if case 2 in Table 15 (e.g., 1 Tx chain on band B and 1 Tx chain on band C) is configured for band C, the UE may determine to switch the Tx chain from being on band A to be on band C, such that 1 Tx chain is on band B and 1 Tx chain is on band C, after the Tx chain switching. As another example, if the current Tx chain state is case 1, as shown in Table 16 (1 Tx chain on band A and 1 Tx chain on band B), and a UL transmission is scheduled on band C, the UE may determine on which bands the Tx chains are to be after the Tx chain switching based on the RRC configuration for band C. For example, if the current Tx chain state is case 9, as shown in Table 16 (1 Tx chain on band C and 1 Tx chain on band D), which is configured for band C, the UE may determine to switch the Tx chain from being on band A to be on band C, and switch the Tx chain from being on band B to be on band D, such that 1 Tx chain is on band C and 1 Tx chain is on band D, after the Tx chain switching.

Alt. 6: Switch the Tx chain that is on a band supporting 2 Tx chains to be on the target band. For example, if band A supports at most 1 Tx chain and band B supports at most 2 Tx chains, the current Tx chain state may be case 1 in Table 15, and a 1-port transmission on band C may be scheduled, then the Tx chain on band B may be switched to be on band C. If both Tx chains are separately on two bands that support at most 2 Tx chains, the Tx chain may be switched on a predefined or preconfigured band or the above methods may be used.

Alt. 7: The gNB scheduling and configuration should avoid the ambiguity problems. That is, a 2-port UL transmission may be always scheduled on the target band, or a simultaneous UL transmission may be scheduled on another band besides the UL transmission on the target band.

Alt. 8: Switch the Tx chain based on different criteria, including at least one of: (1) the associating band is under a DRX active period (e.g., no UL transmission); (2) no valid resource (e.g., unlicensed band and/or LBT fails) on the associating band; and (3) the associated band is under beam failure.

### Determination of 1Tx-2Tx or 2Tx-2Tx Mode/Switching Period

To deal with the above-mentioned issues, the following embodiments are proposed. In the following, per-band configuration may be configured in the UL configuration (e.g., via the upinkConfig IE) of one or more carriers on a band. When more than one carrier is configured on the band, the configuration may be the same for the more than one carrier on the band.

Method 2-1: An RRC parameter may be used to configure the 1Tx-2Tx or 2Tx-2Tx mode per band pair. If the Tx chains are within the band pairs configured with the 1Tx-2Tx mode, before and after Tx chain switching, a 1Tx-2Tx chain switching period may be used. Otherwise, a 2Tx-2Tx chain switching period may be used. When the 1Tx-2Tx mode is configured for a band pair (e.g., {band A, band B}), the possible scenarios for the band pair may be 1 Tx chain on each band of the band pair and 2 Tx chains on one of the bands of the band pair (e.g., case 1 and case 4 in Table 15).

In some implementations, a UE may expect that only one band pair is configured with the 1Tx-2Tx mode. In some implementations, when more than two bands are configured, the 1Tx-2Tx mode may be configured for one specific band pair, and the band pairs not configured with the 1Tx-2Tx mode may be assumed to use the 2Tx-2Tx mode.

Method 2-2: A MAC CE or DCI may be used to indicate the 1Tx-2Tx chain switching mode for a band pair. If the Tx chains are within the band pairs indicated with the 1Tx-2Tx mode, before and after Tx chain switching, a 1Tx-2Tx chain switching period may be used. Otherwise, a 2Tx-2Tx chain switching period may be used. In some implementations, the UE may not expect to switch a Tx chain to be on a band that is not included in the band pair indicated, for example, with the 1Tx-2Tx mode by the MAC CE or the DCI. When the 1Tx-2Tx mode is indicated for a band pair (e.g., {band A, band B}), the possible scenarios for the band pair may be 1 Tx chain on each band of the band pair and 2 Tx chains on one of the bands of the band pair (e.g., case 1 and case 4 in Table 15).

Method 2-3: An RRC parameter may be used to configure the 1Tx-2Tx or 2Tx-2Tx mode per UE. If the 1Tx-2Tx mode is configured, a 1Tx-2Tx chain switching period may be used. If the 2Tx-2Tx mode is configured, a 2Tx-2Tx chain switching period may be used. The UE may expect to be configured with the 2Tx-2Tx mode when more than one or two bands are configured and the configured bands are scheduled with at most 2 Tx (UL) transmissions.

It should be noted that Method 2-1 and Method 2-2 may be combined, such that the RRC configured band pair that is using the 1Tx-2Tx mode may be changed by a MAC CE or DCI.

For the above described methods, when the 1Tx-2Tx mode is configured, or indicated for a band pair, the UE may fix or keep a Tx chain on a band that supports 2 Tx transmissions, such that the reported 1Tx-2Tx chain switching period may be used.

### Length of Switching Period and Switching Location

To deal with the above-mentioned issues, the following embodiments are proposed. In the following, a per-band configuration may be configured in the UL configuration (e.g., via the upinkConfig IE) of one or more carriers on a band. When more than one carrier is configured on the band, the configuration may be the same for the more than one carrier on the band.

Method 3-1: A UE may report the length of switching period for each supported band pair in a band combination. If the 1Tx-2Tx mode is supported for a band pair, the length of switching period for the 1Tx-2Tx mode may be reported for the band pair. If the 2Tx-2Tx mode is supported for a band pair, the length of switching period for the 2Tx-2Tx mode may be reported for the band pair.

Alt. 1: For a Tx chain switching that involves one or two Tx chains being switched within a band pair, the Tx chain switching period of the band pair may be used. A 1Tx-2Tx chain switching period may be used if the 1Tx-2Tx mode is configured or indicated for the band pair, and a 2Tx-2Tx chain switching period may be used if the 2Tx-2Tx mode is configured or indicated for the band pair. For a Tx chain switching that involves two Tx chains being switched within two separate band pairs, the larger one of the Tx chain switching periods of the two band pairs may be used. It should be noted that the 2Tx-2Tx chain switching period of the band pairs may be used to determine the switching period if the two Tx chains are not within a band pair before and after the Tx chain switching.

For example, a UE may report a 35 s switching period for {band A, band B}, a 140 s switching period for {band B, band C}, a 210 s switching period for {band A, band C}, and a 140 s switching period for {band B, band D}. If a Tx chain switching is triggered to switch from case 1 to case 3 in Table 15, since 1 Tx chain is switched between {band B, band C}, the switching period may be 140 s. If a Tx chain switching is triggered to switch from case 1 to case 5 in Table 15, since 1 Tx chain is switched between {band A, band C} and 1 Tx chain is switched between {band B, band C}, the switching period may be max(140 s, 210 s)=210 s. If a Tx chain switching is triggered to switch from case 1 to case 9 in Table 16, since 1 Tx chain is switched between {band A, band C} and 1 Tx chain is switched between {band B, band D}, the switching period may be max(210 s, 140 s)=210 s.

Alt. 2: Besides the length of switching period for each supported band pair in a band combination, a UE may report the length of switching period for subsets of bands of the band combination. A subset of bands may include three or four bands in the band combination. For a Tx chain switching that involves one or two Tx chains being switched within a band pair, the Tx chain switching period of the band pair may be used. For other cases, the length of switching period for a subset of bands may be used if the two Tx chains are on the bands of the subset of bands before or after the Tx chain switching.

For example, a UE may report a 35 s switching period for {band A, band B}, a 140 s switching period for {band B, band C}, and a 140 s switching period for {band A, band C}. In addition, the UE may report a 210 s switching period for {band A, band B, band C}. If a Tx chain switching is triggered to switch from case 1 to case 4 in Table 15, since the Tx chain switching is within {band A, band B}, the switching period may be 35 s. If a Tx chain switching is triggered to switch from case 1 to case 5 in Table 15, since the two Tx chains are on band A, band B, and band C before or after the Tx chain switching, the switching period may be 210 s.

Method 3-2: A UE may report the length of switching period for a band combination. When more than two bands in the band combination are configured, the length of switching period for the band combination may be used for any Tx chain switching.

Method 3-3: A UE may report the length of switching period per switching scenario in a band combination. That is, any combination of cases before and after a Tx chain switching may be reported via the UE capability signaling. For example, if a Tx chain switching is triggered to switch from case 1 to case 5 in Table 15, the switching period for the switch from case 1 to case 5 may be used. For example, if a Tx chain switching is triggered to switch from case 3 to case 4 in Table 15, the switching period for the switch from case 3 to case 4 may be used. In some implementations, for a Tx chain switching that involves one or two Tx chains being switched within a band pair, the Tx chain switching period of the band pair may be used as in Method 3-1, and for other cases, Method 3-3 may be used.

Method 4-1: The switching location may be configured per band. That is, more than one band may be configured with a switching location in a band combination. For a Tx chain switching to be on a target band (e.g., band C), a UE may determine that the switching location is on the target band, (e.g., the UL transmission on the target band may be interrupted when the gap between the end of the last UL transmission and the start of the scheduled or configured UL transmission on the target band is less than T_{switch}) if a switching location is configured on the target band and not configured on the bands before the Tx chain switching. If a switching location is configured on the target band, and also configured on the band before the Tx chain switching, the UE may determine that the switching location is on the band before the Tx chain switching. If a switching location is neither configured on the target band nor on the band before the Tx chain switching, the UE may not expect that the gap between UL transmissions is less than the switching period.

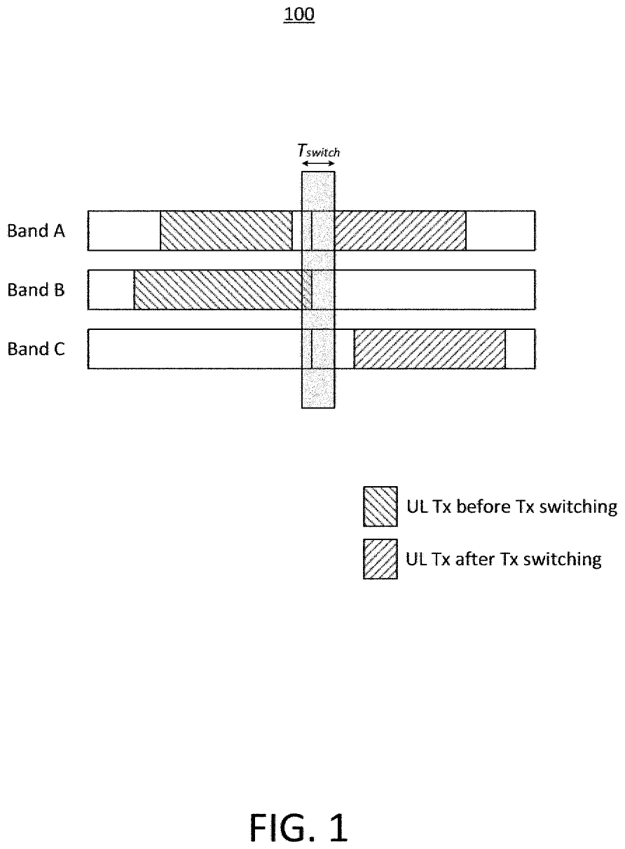

FIG. 1 is a diagram 100 illustrating a UL Tx chain switching, according to an example implementation of the present disclosure. As shown in FIG. 1, there may be simultaneous UL transmissions on band A and band B before the Tx chain switching, and there may be simultaneous UL transmissions on band A and band C after the Tx chain switching. If both band B and band C are configured with the switching location, the switching location may be located on band B since the time gap between the start of the UL transmission on band A after the Tx chain switching and the end of the UL transmission on band B is less than T_{switch}. In other words, the switching location may depend on the UL transmissions on bands that are not configured with a switching location.

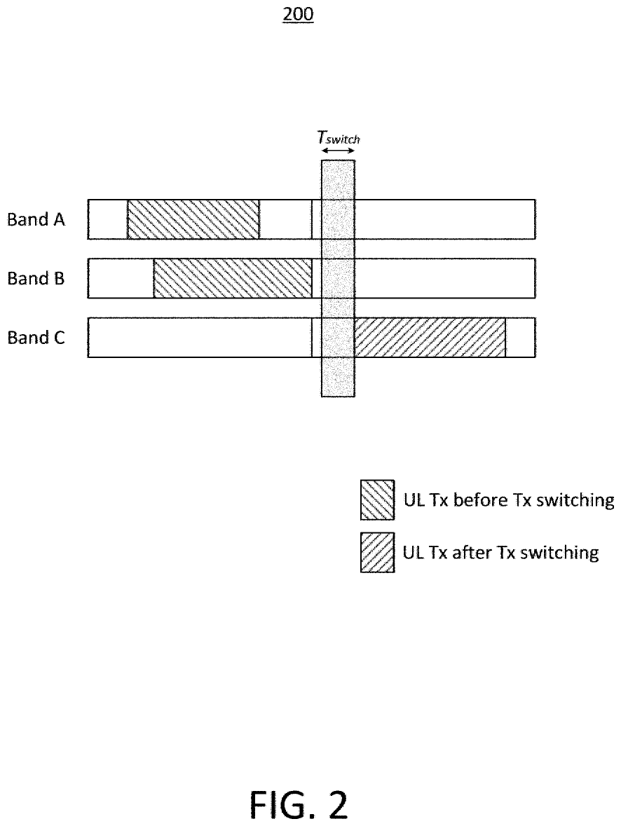

FIG. 2 is a diagram 200 illustrating a UL Tx chain switching, according to another example implementation of the present disclosure. As shown in FIG. 2, there may be simultaneous UL transmissions on band A and band B before the Tx chain switching, and there may be UL transmission on band C after the Tx chain switching. If band A is configured with the switching location, the switching location may be located on band A. However, the UL transmission on band A may not be interrupted in this example implementation, since the gap between the end of the UL transmission on band B and the start of the UL transmission on band C is larger than T_{switch}. The UE may expect that the gap between the end of the UL transmission on band B and the start of the UL transmission on band C is not smaller than T_{switch}.

Method 4-2: The switching location may be configured per band pair. For a Tx chain switching within a band pair, the switching location may be on the band configured for the band pair.

Alt. 1: When 2 Tx chains are switched, respectively, within 2 band pairs, the switching location of the 2 band pairs may not be contradictory. For example, if the Tx chain switching is from case 1 to case 5 in Table 15, the switching location may be configured on band A for {band A, band C} and configured on band B for {band B, band C}, or configured on band C for both band pairs. If the switching location is configured on band A for {band A, band C} and configured on band B for {band B, band C}, the latter part of UL transmission on band A or band B may be interrupted when the gap between the end of the UL transmission on band A or band B and the start of the UL transmission on band C is less than the switching period.

For a Tx chain switching to be on a target band (e.g., band C), a UE may determine the switching location based on the configured switching locations for the two band pairs including the target band (e.g., {band A, band C}, {band B, band C}). The switching location may be on the target band if the switching locations for the two band pairs are both on the target band. The switching location may be on one of the two bands before the Tx chain switching if the switching locations for the two band pairs are both not on the target band.

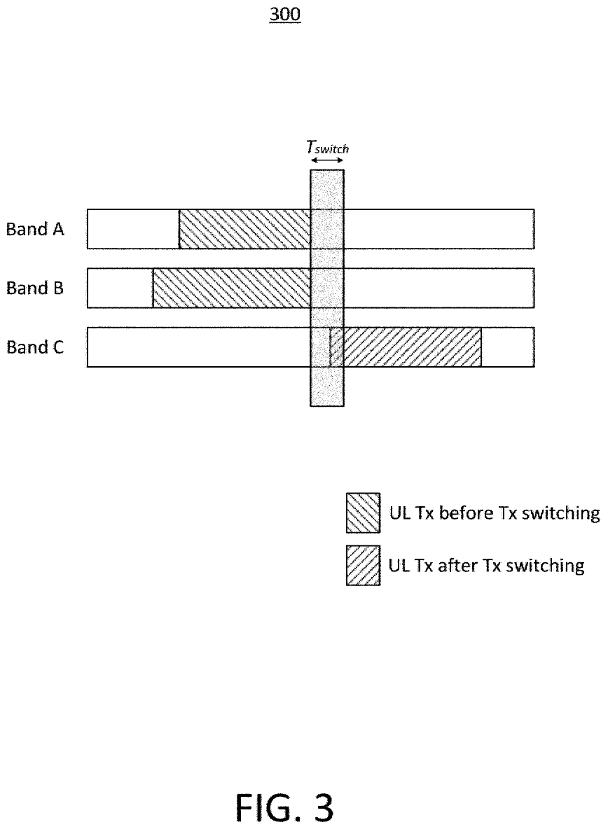

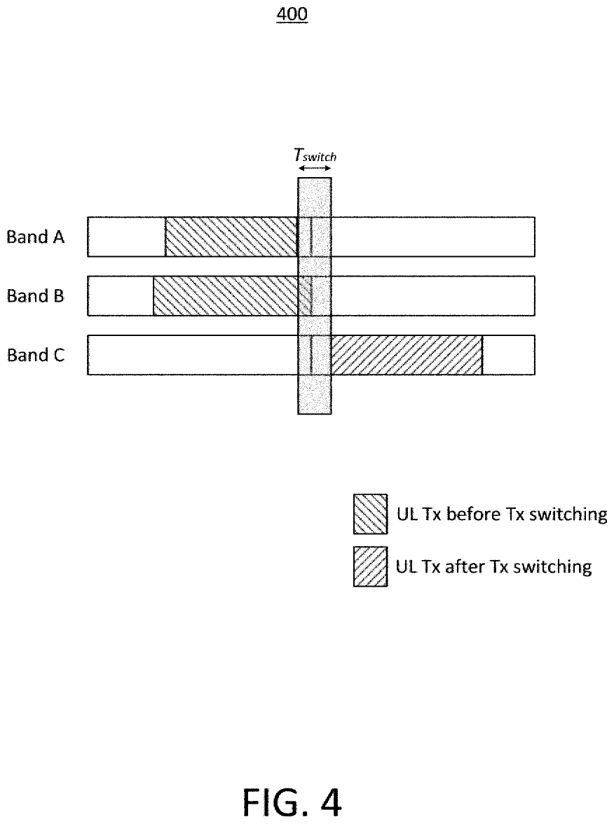

Alt. 2: When 2 Tx chains that are switched, respectively, within 2 band pairs, the switching locations of the 2 band pairs may be contradictory. For example, if a Tx chain switching is from case 1 to case 5 in Table 15, the switching location may be configured on the target band for one band pair (e.g., {band A, band C}), and the switching location may not be on the target band for the other band pair (e.g., {band B, band C}), then the UE may determine the switching location based on the principle that the UL transmission on a band of a band pair should not be interrupted by the UL transmission of the other band of the band pair, which is configured with the switching location. FIG. 3 is a diagram 300 illustrating a UL Tx chain switching, according to another example implementation of the present disclosure. As shown in FIG. 3, the switching location may be on band C for the above configurations. FIG. 4 is a diagram 400 illustrating a UL Tx chain switching, according to another example implementation of the present disclosure. As shown in FIG. 4, the switching location may be on band B for the above configurations.

Method 4-3: The switching location may be configured per subset of bands in a band combination. A subset of bands may include three or four bands in the band combination. For a Tx chain switching within a subset of bands (e.g., 2 Tx chains are on the bands in the subset of bands before or after Tx chain switching), the switching location may be on the band configured with a switching location.

Method 4-4: The switching location may be configured per UE. That is, only one band in a band combination may be configured with a switching location. The switching location may be on the band configured with a switching location if a Tx chain is on the band configured with a switching location before or after Tx chain switching. If there is no Tx chain on the band configured with a switching location before and after Tx chain switching, the UE may not expect that the gap between transmission before and after Tx chain switching is less than the switching period.

Method 4-5: The switching location may be determined based on one or more conditions. The one or more conditions may include: 1) the frequency (e.g., the switching location may always take place on higher frequency/band); and 2) the TDD configuration (e.g., the switching location may always take place on the band with the most available UL resources).

In some implementations, an anchor band may be configured per UE. If a Tx chain is on the anchor band before the Tx chain switching, the switching location may be on one of the non-anchor bands (e.g., bands that are not the anchor band) after Tx chain switching. If a Tx chain is on the anchor band after Tx chain switching, the switching location may be on one of the non-anchor bands before the Tx chain switching. If there is no Tx chain on the anchor band before or after Tx chain switching, the UE may not expect that the gap between transmission before and after Tx chain switching is less than the switching period.

### Triggering Condition for Tx Chain Switching

Method 5: For a scheduled or configured UL transmission, the UE may determine the target Tx chain state based on the current Tx chain state, whether there is another simultaneous UL transmission, and the number of ports for the scheduled or configured UL transmission. The Tx chain switching may be performed if the target Tx chain state is determined to be different from the current Tx chain state.

The definition of simultaneous UL transmission may be specified as follows. If two UL transmissions on two separate bands are within a slot, a minimum slot, or a span, these two UL transmissions may be simultaneous UL transmissions. The slot may be defined based on a reference SCS. The reference SCS may be the largest SCS among the SCS of the active BWPs of the more than two bands that are configured. In some implementations, the reference SCS may be the smallest SCS among the SCS of the active BWPs of the more than two bands that are configured. The alternative may reduce the frequency of Tx chain switching. Which alternative to be used may be determined by the UE capability or gNB configuration.

Since the DCI scheduling two simultaneous UL transmissions may be transmitted in different times, a timeline may be defined for a second DCI after a first DCI scheduling a UL transmission that triggers a Tx chain switching.

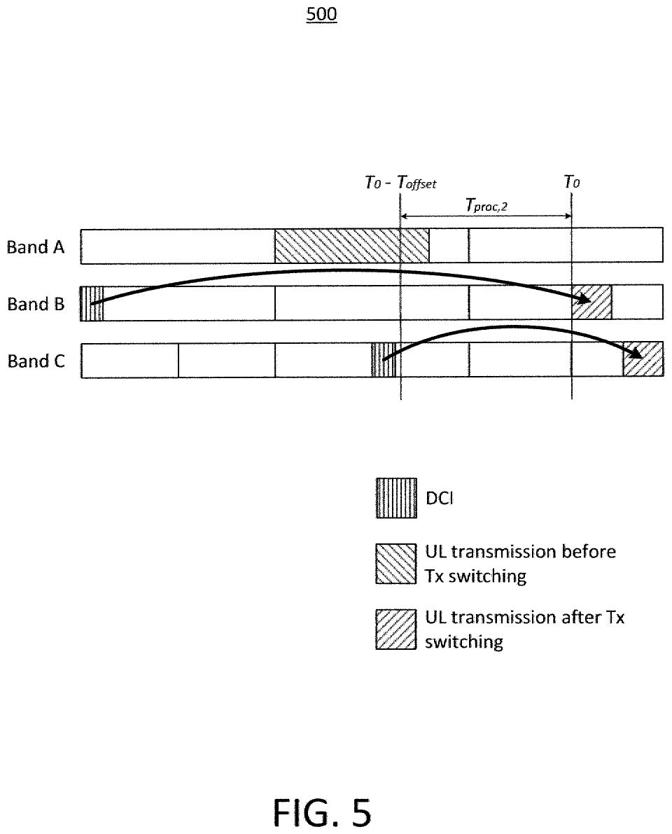

FIG. 5 is a diagram 500 illustrating a scheduling timeline for simultaneous UL transmission, according to an example implementation of the present disclosure. As shown in FIG. 5, first DCI scheduling a first UL transmission in a slot (e.g., a 1-port transmission on band B) may trigger a Tx chain switching to be on a first target case (e.g., 1 Tx chain on band A and 1 Tx chain on band B), and the UE may determine a second target case (e.g., 1 Tx chain on band B and 1 Tx chain on band C) based on second DCI received before T₀-T_{offset} that schedules a 1-port transmission on band C in the slot, where T₀ may be the start of the first UL transmission and T_{offset} may be the processing time for the first UL transmission, T_{proc,2}. T_{proc,2}=max((N₂+d_{2,1}+d₂)(2048+144)·κ2^{-μ}. T_{C}+Tₑₓₜ+T_{switch}, d_{2,2}) as defined in the 3GPP TS 38.214, where T_{switch} may be the switching period corresponding to the first target case. In some implementations, T_{switch} may be the maximum of the switching period corresponding to the first target case and the switching period corresponding to the second target case.

In some implementations, the two UL transmissions may be determined as simultaneous UL transmissions if the starting symbols of the two UL transmissions are in the same slot. In some implementations, the two UL transmissions may be determined as simultaneous UL transmissions if at least one symbol of each of the two UL transmissions are in the same slot. In some implementations, the two UL transmissions may be determined as simultaneous UL transmissions if the two UL transmissions overlap in the time domain.

For SUL and CA option 1, since a UE may only perform UL transmission on one band at a time, the UE may switch between case 4, case 5, and case 6 in Table 15 if the maximum numbers of ports of scheduled or configured UL transmissions on band A, band B, and band C are all equal to 2. If the maximum numbers of ports of scheduled or configured UL transmissions on some bands are equal to 1, some cases among case 1, case 2, and case 3 in Table 15 may replace some cases among case 4, case 5, and case 6 in Table 15. For example, if the maximum number of ports of scheduled or configured UL transmissions on band A is equal to 1, then the UE may switch between case 1, case 4, and case 5 in Table 15. The UE may trigger a Tx chain switching when the UE is to transmit a 1-port or 2-port transmission on at least one UL carrier on one band and the preceding UL transmission was a 1-port or 2-port transmission on at least one carrier on another band. It should be noted that regardless of the cases between which the UE performs a Tx chain switching, the triggering condition may be the same. In other words, the UE may not need to determine whether or not to perform the Tx chain switching based on the current Tx chain state.

For CA option 2, a UE may switch between case 1 to case 6 in Table 15 if the maximum numbers of ports of scheduled or configured UL transmission on band A, band B, and band C are all equal to 2. The UE may trigger a Tx chain switching when one of the following conditions is met.
The UE is to transmit a 2-port transmission on at least one UL carrier on a first band, the preceding UL transmission was a 1-port transmission on at least one UL carrier on the first band and/or a 1-port transmission on at least one UL carrier on a second band, and the UE is under the operation state in which 2-port transmission cannot be supported on the first band. For example, the UE may switch from case 1 to case 6 in Table 15.
The UE is to transmit a 1-port transmission or a 2-port transmission on at least one UL carrier on a first band, the preceding UL transmission was a 1-port transmission on at least one UL carrier on a second band, and the UE is under the operation state in which 1-port transmission can be supported on the second band and a third band. For example, the UE may switch from case 1 to case 5 in Table 15.
The UE is to transmit a 1-port transmission or a 2-port transmission on at least one UL carrier on a first band, the preceding UL transmission was a 1-port transmission or a 2-port transmission on at least one UL carrier on a second band, and the UE is under the operation state in which 2-port transmission can be supported on the second band. For example, the UE may switch from case 4 to case 5 in Table 15.
The UE is to transmit a 1-port transmission on at least one UL carrier on a first band and a 1-port transmission on at least one UL carrier on a second band, the preceding UL transmission was a 1-port transmission or a 2-port transmission on at least one UL carrier on the first band, and the UE is under the operation state in which 2-port transmission can be supported on the first band. For example, the UE may switch from case 4 to case 1 in Table 15.
The UE is to transmit a 1-port transmission on at least one UL carrier on a first band and a 1-port transmission on at least one UL carrier on a second band, the preceding UL transmission was a 1-port transmission or a 2-port transmission on at least one UL carrier on a third band, and the UE is under the operation state in which 1-port transmission or 2-port transmission can be supported on the third band. For example, the UE may switch from case 5 to case 1 in Table 15.
The UE is to transmit a 1-port transmission on at least one UL carrier on a first band and a 1-port transmission on at least one UL carrier on a second band, the preceding UL transmission was a 1-port transmission on at least one UL carrier on the first band and/or a 1-port transmission on at least one UL carrier on a third band, and the UE is under the operation state in which 1-port transmission can be supported on the first band or the third band. For example, the UE may switch from case 1 to case 2 in Table 15.

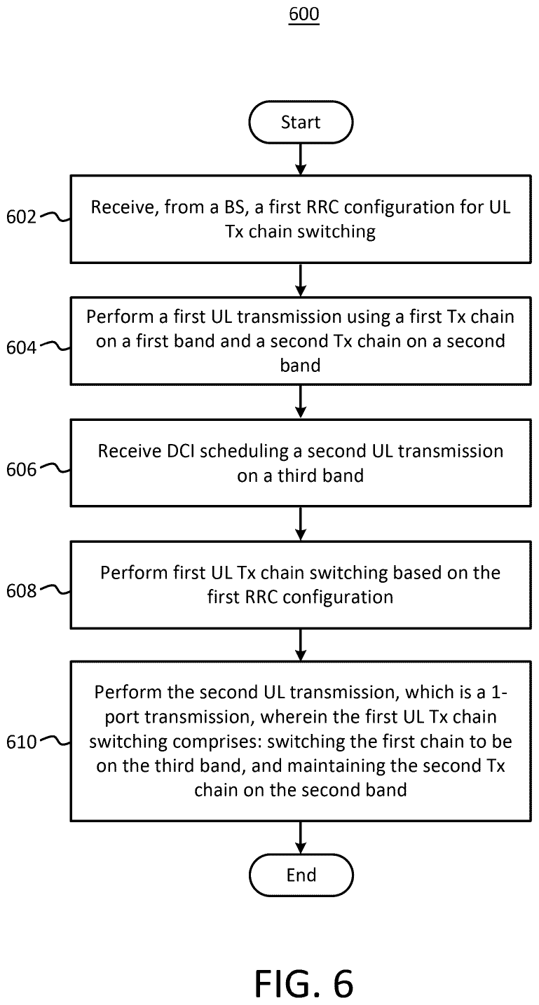

FIG. 6 is a flowchart illustrating a method/process 600 performed by a UE for Tx chain switching between multiple bands, according to an example implementation of the present disclosure. In action 602, process 600 may start by receiving, from a BS, a first RRC configuration for UL Tx chain switching. In action 604, process 600 may perform a first UL transmission using a first Tx chain on a first band and a second Tx chain on a second band. In action 606, process 600 may receive DCI scheduling a second UL transmission on a third band. In action 608, process 600 may perform first UL Tx chain switching based on the first RRC configuration. In action 610, process 600 may perform the second UL transmission, which is a 1-port transmission. The first UL Tx chain switching may include: switching the first Tx chain to the third band, and keeping the second Tx chain on the second band. The process may then end.

In some implementations, the first UL Tx chain switching may further include switching the first Tx chain to the third band and keeping the second Tx chain on the second band in a case that the first RRC configuration indicates that the third band is associated with the second band.

In some implementations, the first RRC configuration may indicate a state of the Tx chains for the UL Tx chain switching, and the first UL Tx chain switching may be performed in a case that the state indicates only one Tx chain to be switched to be on the third band.

In some implementations, the UE may further perform second UL Tx chain switching in a case that the state indicates two Tx chains to be switched to be on the third band. The second UL Tx chain switching may include switching both the first Tx chain and the second Tx chain to be on the third band.

In some implementations, the UE may further report, to the BS, a first switching period for UL Tx chain switching between the first band and the third band and a second switching period for UL Tx chain switching between the second band and the third band; and determine not to perform any uplink transmission within a maximum of the first switching period and the second switching period in a case that both the first Tx chain and the second Tx chain are switched to be on the third band.

In some implementations, the UE may further report, to the BS, a first switching period for UL Tx chain switching between the first band and the third band and a second switching period for UL Tx chain switching between the second band and the third band; and determine not to perform any uplink transmission within the first switching period in a case that the first Tx chain is switched to be on the third band and the second Tx chain is maintained on the second band.

In some implementations, the UE may transmit, to the BS, UE capability information indicating a support of two Tx chains and a support of Tx chain switching between the first band, the second band, and the third band; and receive, from the BS, a second RRC configuration indicating a band combination including the first band, the second band, and the third band.

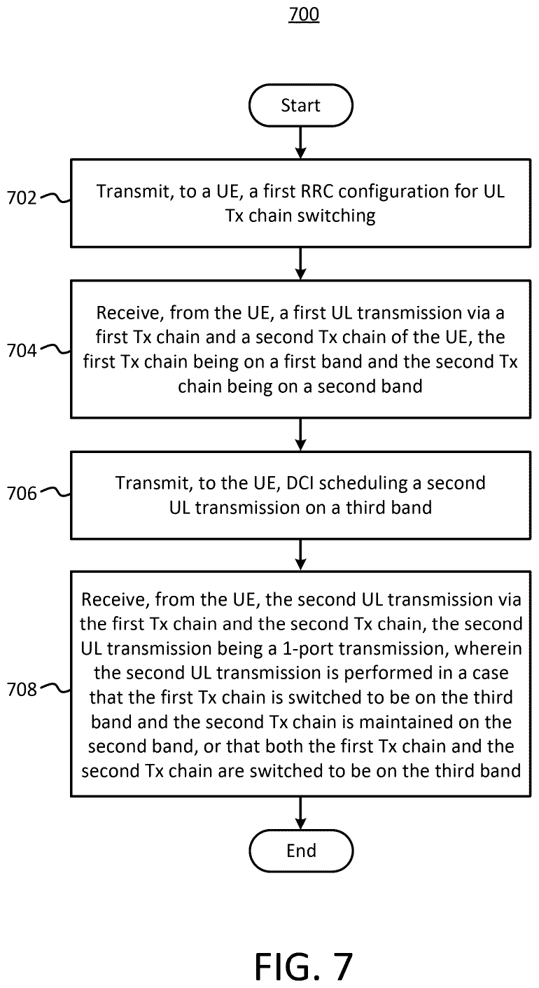

FIG. 7 is a flowchart illustrating a method/process 700 performed by a BS for Tx chain switching between multiple bands, according to an example implementation of the present disclosure. In action 702, process 700 may start by transmitting, to a UE, a first RRC configuration for UL Tx chain switching. In action 704, process 700 may receive, from the UE, a first UL transmission via a first Tx chain and a second Tx chain of the UE, the first Tx chain being on a first band and the second Tx chain being on a second band. In action 706, process 700 may transmit, to the UE, DCI scheduling a second UL transmission on a third band. In action 708, process 700 may receive, from the UE, the second UL transmission via the first Tx chain and the second Tx chain, the second UL transmission being a 1-port transmission. The process may then end. The second UL transmission may be performed in a case that the first Tx chain is switched to be on the third band and the second Tx chain is maintained on the second band, or that both the first Tx chain and the second Tx chain are switched to be on the third band.

In some implementations, the first Tx chain may be switched to be on the third band and the second Tx chain may be maintained on the second band in a case that the first RRC configuration indicates that the third band is associated with the second band.

In some implementations, the first RRC configuration may indicate a state of Tx chains for the UL Tx chain switching.

In some implementations, the first Tx chain may be switched to be on the third band and the second Tx chain is maintained on the second band in a case that the state indicates only one Tx chain to be switched to be on the third band, and both the first Tx chain and the second Tx chain may be switched to be on the third band in a case that the state indicates two Tx chains to be switched to be on the third band.

In some implementations, the BS may further receive, from the UE, a first switching period for UL Tx chain switching between the first band and the third band and a second switching period for UL Tx chain switching between the second band and the third band; and determine not to receive any uplink transmission from the UE within a maximum of the first switching period and the second switching period in a case that both the first Tx chain and the second Tx chain are switched to be on the third band.

In some implementations, the BS may further receive, from the UE, a first switching period for UL Tx chain switching between the first band and the third band and a second switching period for UL Tx chain switching between the second band and the third band; and determine not to receive any uplink transmission from the UE within the first switching period in a case that the first Tx chain is switched to be on the third band and the second Tx chain is maintained on the second band.

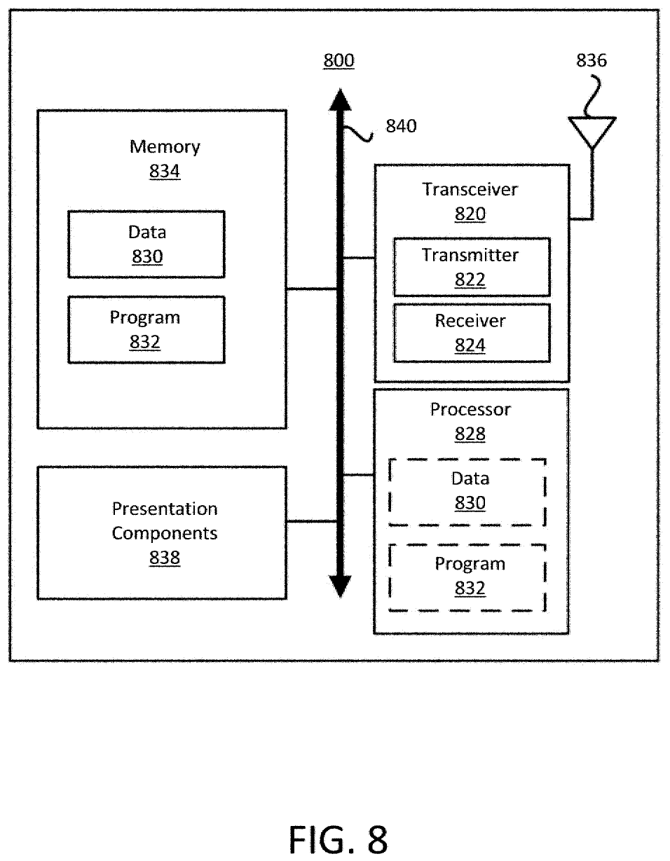

FIG. 8 is a block diagram illustrating a node 800 for wireless communication in accordance with various aspects of the present disclosure. As illustrated in FIG. 8, a node 800 may include a transceiver 820, a processor 828, a memory 834, one or more presentation components 838, and at least one antenna 836. The node 800 may also include an RF spectrum band module, a BS/UE communications module, a network communications module, and a system communications management module, Input/Output (I/O) ports, I/O components, and a power supply (not illustrated in FIG. 8).

Each of the components may directly or indirectly communicate with each other over one or more buses 840. The node 800 may be a UE or a BS that performs various functions disclosed with reference to FIGS. 1 through 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including but not limited to usable, non-usable, and flexibly usable subframes and slot formats. The transceiver 820 may be configured to receive data and control channels.

The node 800 may include a variety of computer-readable media. Computer-readable media may be any available media that may be accessed by the node 800 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include random access memory (RAM), read-only memory (ROM), erasable-programmable ROM (EPROM), electrically-erasable-programmable ROM (EEPROM), flash memory (or other memory technology), compact-disc-ROM (CD-ROM), digital versatile disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store a computer-readable and/or computer-executable program 832 (e.g., instructions and/or software codes) that are configured to, when executed, cause the processor 828 to perform various functions disclosed herein, for example, with reference to FIGS. 1 through 7. Alternatively, the program 832 may not be directly executable by the processor 828 but may be configured to cause the node 800 (e.g., when compiled and executed) to perform various functions disclosed herein.

The processor 828 (e.g., having processing circuitry) may include an intelligent hardware device, e.g., a central processing unit (CPU), a microcontroller, an ASIC, etc. The processor 828 may include memory. The processor 828 may process the data 830 and the program 832 received from the memory 834, and information transmitted and received via the transceiver 820, the baseband communications module, and/or the network communications module. The processor 828 may also process information to send to the transceiver 820 for transmission via the antenna 836 to the network communications module for transmission to a CN.

One or more presentation components 838 may present data indications to a person or another device. Examples of presentation components 838 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed, and many rearrangements, modifications, and substitutions are possible without departing from the scope of the present disclosure.

1. A method performed by a user equipment (UE) for transmission (Tx) chain switching between multiple bands, the method comprising:
receiving, from a base station (BS), a first radio resource control (RRC) configuration for uplink (UL) Tx chain switching;
performing a first UL transmission using a first Tx chain on a first band and a second Tx chain on a second band;
receiving downlink control information (DCI) scheduling a second UL transmission on a third band;
performing first UL Tx chain switching based on the first RRC configuration; and
performing the second UL transmission, which is a I-port transmission, wherein
the first UL Tx chain switching comprises:
switching the first Tx chain to be on the third band, and
maintaining the second Tx chain on the second band.

2. The method of claim 1, wherein the first UL Tx chain switching further comprises:
switching the first Tx chain to be on the third band and maintaining the second Tx chain on the second band in a case that the first RRC configuration indicates that the third band is associated with the second band.

3. The method of claim 1, wherein:
the first RRC configuration indicates a state of Tx chains for the UL Tx chain switching, and
the first UL Tx chain switching is performed in a case that the state indicates only one Tx chain to be switched to be on the third band.

4. The method of claim 3, further comprising:
performing second UL Tx chain switching in a case that the state indicates two Tx chains to be switched to be on the third band, wherein the second UL Tx chain switching comprises switching both the first Tx chain and the second Tx chain to be on the third band.

5. The method of claim 1, further comprising:
reporting, to the BS, a first switching period for UL Tx chain switching between the first band and the third band and a second switching period for UL Tx chain switching between the second band and the third band; and
determining not to perform any uplink transmission within a maximum of the first switching period and the second switching period in a case that both the first Tx chain and the second Tx chain are switched to be on the third band.

6. The method of claim 1, further comprising:
reporting, to the BS, a first switching period for UL Tx chain switching between the first band and the third band and a second switching period for UL Tx chain switching between the second band and the third band; and
determining not to perform any uplink transmission within the first switching period in a case that the first Tx chain is switched to be on the third band and the second Tx chain is maintained on the second band.

7. The method of claim 1, further comprising:
transmitting, to the BS, UE capability information indicating a support of two Tx chains and a support of Tx chain switching between the first band, the second band, and the third band; and
receiving, from the BS, a second RRC configuration indicating a band combination including the first band, the second band, and the third band.

8. A user equipment (UE) for transmission (Tx) chain switching between multiple bands, the UE comprising:
one or more processors; and
at least one non-transitory computer-readable medium coupled to at least one of the one or more processors, and storing one or more computer-executable instructions that, when executed by the at least one of the one or more processors, cause the UE to:
receive, from a base station (BS), a first radio resource control (RRC) configuration for uplink (UL) Tx chain switching;
perform a first UL transmission using a first Tx chain on the first band and a second Tx chain on the second band;
receive downlink control information (DCI) scheduling a second UL transmission on a third band;
perform first UL Tx chain switching based on the first RRC configuration; and
perform the second UL transmission, which is a 1-port transmission, wherein
the first UL Tx chain switching comprises:
switching the first Tx chain to be on the third band, and
maintaining the second Tx chain on the second band.

9. The UE of claim 8, wherein the first UL Tx chain switching further comprises:
switching the first Tx chain to be on the third band and maintaining the second Tx chain on the second band in a case that the first RRC configuration indicates that the third band is associated with the second band.

10. The UE of claim 8, wherein:
the first RRC configuration indicates a state of Tx chains for the UL Tx chain switching, and
the first UL Tx chain switching is performed in a case that the state indicates only one Tx chain to be switched to be on the third band.

11. The UE of claim 10, wherein the one or more computer-executable instructions, when executed by the at least one of the one or more processors, further cause the UE to:
perform second UL Tx chain switching in a case that the state indicates two Tx chains to be switched to be on the third band, wherein the second UL Tx chain switching comprises switching both the first Tx chain and the second Tx chain to be on the third band.

12. The UE of claim 8, wherein the one or more computer-executable instructions, when executed by the at least one of the one or more processors, further cause the UE to:
report, to the BS, a first switching period for UL Tx chain switching between the first band and the third band and a second switching period for UL Tx chain switching between the second band and the third band; and
determine not to perform any uplink transmission within a maximum of the first switching period and the second switching period in a case that both the first Tx chain and the second Tx chain are switched to be on the third band.

13. The UE of claim 8, wherein the one or more computer-executable instructions, when executed by the at least one of the one or more processors, further cause the UE to:
report, to the BS, a first switching period for UL Tx chain switching between the first band and the third band and a second switching period for UL Tx chain switching between the second band and the third band; and
determine not to perform any uplink transmission within the first switching period in a case that the first Tx chain is switched to be on the third band and the second Tx chain is maintained on the second band.

14. The UE of claim 8, wherein the one or more computer-executable instructions, when executed by the at least one of the one or more processors, further cause the UE to:
transmit, to the BS, UE capability information indicating a support of two Tx chains and a support of Tx chain switching between the first band, the second band, and the third band; and
receive, from the BS, a second RRC configuration indicating a band combination including the first band, the second band, and the third band.

15. A base station (BS) for transmission (Tx) chain switching between multiple bands, the BS comprising:
one or more processors; and
at least one non-transitory computer-readable medium coupled to at least one of the one or more processors, and storing one or more computer-executable instructions that, when executed by the at least one of the one or more processors, cause the BS to:
transmit, to a user equipment (UE), a first radio resource control (RRC) configuration for uplink (UL) Tx chain switching;
receive, from the UE, a first UL transmission via a first Tx chain and a second Tx chain of the UE, the first Tx chain being on a first band and the second Tx chain being on a second band;
transmit, to the UE, downlink control information (DCI) scheduling a second UL transmission on a third band; and
receive, from the UE, the second UL transmission via the first Tx chain and the second Tx chain, the second UL transmission being a 1-port transmission, wherein
the second UL transmission is performed in a case that the first Tx chain is switched to be on the third band and the second Tx chain is maintained on the second band, or that both the first Tx chain and the second Tx chain are switched to be on the third band.

16. The BS of claim 15, wherein:
the first Tx chain is switched to be on the third band and the second Tx chain is maintained on the second band in a case that the first RRC configuration indicates that the third band is associated with the second band.

17. The BS of claim 15, wherein:
the first RRC configuration indicates a state of Tx chains for the UL Tx chain switching.

18. The BS of claim 17, wherein:
the first Tx chain is switched to be on the third band and the second Tx chain is maintained on the second band in a case that the state indicates only one Tx chain to be switched to be on the third band; and
both the first Tx chain and the second Tx chain are switched to be on the third band in a case that the state indicates two Tx chains to be switched to be on the third band.

19. The BS of claim 15, wherein the one or more computer-executable instructions, when executed by the at least one of the one or more processors, further cause the BS to:
receive, from the UE, a first switching period for UL Tx chain switching between the first band and the third band and a second switching period for UL Tx chain switching between the second band and the third band; and
determine not to receive any uplink transmission from the UE within a maximum of the first switching period and the second switching period in a case that both the first Tx chain and the second Tx chain are switched to be on the third band.

20. The BS of claim 15, wherein the one or more computer-executable instructions, when executed by the at least one of the one or more processors, further cause the BS to:
receive, from the UE, a first switching period for UL Tx chain switching between the first band and the third band and a second switching period for UL Tx chain switching between the second band and the third band; and
determine not to receive any uplink transmission from the UE within the first switching period in a case that the first Tx chain is switched to be on the third band and the second Tx chain is maintained on the second band.
